(19) United States
(12) Patent Application Publication
(10) Pub. No.: US 2020/0284041 A1
(43) Pub. Date: Sep. 10, 2020

(54) FRUSTRUMED BALUSTER CONNECTOR FOR RAIL BANISTER

(71) Applicant: Roger Legault, Val-des-Monts (Quebec) (CA)

(72) Inventor: Roger Legault, Val-des-Monts (Quebec) (CA)

(21) Appl. No.: 16/811,706

(22) Filed: Mar. 6, 2020

Related U.S. Application Data
(60) Provisional application No. 62/816,020, filed on Mar. 8, 2019.

(51) Int. Cl. E04F 11/18; F16B 7/18

(52) U.S. Cl. CPC E04F 11/1817; E04F 2011/1827; F16B 7/18

(57) ABSTRACT

Frustrumed baluster connector for rail banister, including: a base, for adapting the connector to a rail; a body, for frictionally fitting a baluster, rigidly supported to said base; a frustrum, for releasably engaging the baluster to the rail, progressively conformed to said body; and a hole, for receiving a screw, centrally set to said frustrum, centrally set to said body, and centrally counterbored to said base. The frustrum enables frustrumly engaging the connector to a corresponding baluster in a frustrumly engaged position before pressure is applied to put the baluster into a final assembly position.

### CROSS-REFERENCE TO RELAYED APPLICATIONS

The present application is related to and claims convention priority from U.S. Provisional Patent Application 62/816,020 filed Mar. 8, 2019, for FRUSTRUMED BALUSTER CONNECTOR FOR RAIL BANISTER, by Roger Legault.

### TECHNICAL FIELD

This application relates to baluster connectors in general, and to a frustrumed baluster connector for rail banisters, in particular.

### SUMMARY

According to one aspect of the present invention, there is provided a frustrumed baluster connector for rail banisters.

One general aspect includes a frustrumed baluster connector for rail banister, including: means for adapting the connector to a rail; means for frictionally fitting a baluster, rigidly supported to said means for adapting the connector to a rail; means for releasably engaging the baluster to the rail, progressively conformed to said means for frictionally fitting the baluster; and means for receiving a screw, centrally set to said means for releasably engaging the baluster to a rail, centrally set to said means for frictionally fitting the baluster, and centrally counterbored to said means for adapting the connector to the rail.

Implementations may include one or more of the following features. The frustrumed baluster connector for rail banister in accordance where said means for adapting the connector to a rail includes a base. The frustrumed baluster connector for rail banister in accordance where said means for frictionally fitting a baluster includes a body. The frustrumed baluster connector for rail banister in accordance where said means for releasably engaging the baluster to a rail includes a frustrum. The frustrumed baluster connector for rail banister in accordance where said means for receiving a screw includes a hole.

One general aspect includes a frustrumed baluster connector for rail banister, including: a base, for adapting the connector to a rail; a body, for frictionally fitting a baluster, rigidly supported to said base; a frustrum, for releasably engaging the baluster to the rail, progressively conformed to said body; and a hole, for receiving a screw, centrally set to said frustrum, centrally set to said body, and centrally counterbored to said base.

Implementations may include one or more of the following features. The frustrumed baluster connector for rail banister in accordance further including: an angle piece, for further adapting the base to an angle of the rail, centrally set to said hole, and rigidly connected to said base. The frustrumed baluster connector for rail banister in accordance further including a flange, for further frictional engagement with a baluster, perimetrically connected to said body. The frustrumed baluster connector for rail banister in accordance further including. The frustrumed baluster connector may also include a square profiled portion, for conforming to the profile of the baluster. The frustrumed baluster connector for rail banister in accordance further including. The frustrumed baluster connector may also include a circular profiled portion, for conforming to the profile of the baluster. The frustrumed baluster connector for rail banister in accordance where the frustrum has a conical shape. The frustrumed baluster connector for rail banister in accordance where the frustrum has a pyramidal shape. The method of frustrumed baluster connector for rail banister in accordance further including the step of frustrumly engaging the connector to a corresponding baluster in a frustrumly engaged position before pressure is applied to put the baluster into a final assembly position.

One general aspect includes a method of frustrumed baluster connector for rail banister, the method including the steps of: providing a base, for adapting the connector to a rail; providing a body, for frictionally fitting a baluster, rigidly supported to said base; providing a frustrum, for releasably engaging the baluster to the rail, progressively conformed to said body; and providing a hole, for receiving a screw, centrally set to said frustrum, centrally set to said body, and centrally counterbored to said base.

Other aspects and features of the present invention will become apparent to those ordinarily skilled in the art upon review of the following description of specific embodiments of a frustrumed baluster connector for rail banister in conjunction with the accompanying drawing figures.

### BRIEF DESCRIPTION OF THE DRAWINGS

Embodiments of the present invention will now be described, by way of example only, with reference to the accompanying drawing figures, wherein:

FIG. 1 is a front view of two plumb posts a given distance apart for an in-line rail;

FIG. 2 is a top view of a top and bottom rail marked a given distance apart on centre starting from the centre;

FIG. 3 is a top view of the top and bottom rail with a straight connector screwed onto each mark;

FIG. 4 is a perspective view of a rail support that can be attached to the end of the top and bottom rails;

FIG. 5 is a front view of an ideal assembly of an in-line rail banister combining the top rail, bottom rail, connectors, and balusters;

FIG. 6 is a front view of two plumb posts a given distance apart for a stair rail;

FIG. 7 is a top view of a top and bottom rail marked a given distance apart on centre starting from the centre;

FIG. 8 is a perspective view of a top or bottom rail with an angled connector screwed onto each mark;

FIG. 9 is a perspective view of a rail support that can be attached to the end of the top and bottom rails;

FIG. 10 is a perspective view of the rail support that can be attached to the plumb posts;

FIG. 11 is a front view of an ideal assembly of a stair rail banister combining the top rail, bottom rail, connectors, and balusters;

FIG. 12 is a front perspective view of a typical disconnected final assembly position of an in-line rail banister using traditional in-line connectors;

FIG. 13 is a detailed view of a first traditional in-line connector disconnected from its baluster;

FIG. 14 is a front perspective view of a typical final assembly failure of the in-line rail banister;

FIG. 15 is a detailed view of the traditional in-line connector connected to its baluster;

FIG. 16 is a front perspective view of a typical disconnected final assembly position of a stair rail banister;

FIG. 17 is a detailed view of a traditional angled connector disconnected from its baluster;

FIG. 18 is a front perspective view of a typical final assembly failure of the stair rail banister;

FIG. 19 is a detailed view of the traditional angled connector connected to its baluster;

FIG. 20 is a front perspective view of an in-line conical frustrum connector provided in accordance with an embodiment of the present application;

FIG. 21 is a front view of the in-line conical frustrum connector;

FIG. 22 is a side view of the in-line conical frustrum connector;

FIG. 23 is a top view of the in-line conical frustrum connector;

FIG. 24 is a sectional view of the in-line conical frustrum connector along section 24 of FIG. 23;

FIG. 25 is a front perspective view of a disconnected final assembly position of an in-line rail banister using in-line conical frustrum connectors;

FIG. 26 is a detailed view of a first in-line conical frustrum connector;

FIG. 27 is a front perspective view of a correctable frustrum final assembly position of the in-line rail banister using in-line conical frustrum connectors;

FIG. 28 is a detailed view of the first in-line conical frustrum connector frustrumly engaged with its baluster;

FIG. 29 is a front perspective view of a correct frustrum final assembly position of the in-line rail banister using in-line conical frustrum connectors;

FIG. 30 is a front perspective view of a final assembly success of the in-line rail banister using in-line conical frustrum connectors;

FIG. 31 is a front perspective view of an angular conical frustrum connector provided in accordance with an embodiment of the present application;

FIG. 32 is a front view of the angular conical frustrum connector;

FIG. 33 is a side view of the angular conical frustrum connector;

FIG. 34 is a top view of the angular conical frustrum connector;

FIG. 35 is a sectional view of the angular conical frustrum connector along section 35 of FIG. 34;

FIG. 36 is a front perspective view of a disconnected final assembly position of an stair rail banister using angular conical frustrum connectors;

FIG. 37 is a detailed view of a first angular conical frustrum connector;

FIG. 38 is a front perspective view of a correctable frustrum final assembly position of the stair rail banister using angular conical frustrum connectors;

FIG. 39 is a detailed view of the first angular conical frustrum connector frustrumly engaged with its baluster;

FIG. 40 is a front perspective view of a correct frustrum final assembly position of the stair rail banister using angular conical frustrum connectors;

FIG. 41 is a detailed view of the first angular conical frustrum connector frustrumly engaged with its baluster;

FIG. 42 is a front perspective view of a correct frustrum final assembly success of the stair rail banister using angular conical frustrum connectors;

FIG. 43 is a perspective view of an in-line conical frustrum connector provided in accordance with an embodiment of the present application;

FIG. 44 is a front view of the in-line conical frustrum connector;

FIG. 45 is a view of the in-line conical frustrum connector;

FIG. 46 is a top view of the in-line conical frustrum connector;

FIG. 47 is a sectional view of the in-line conical frustrum connector along section 47 of FIG. 46;

FIG. 48 is a perspective view of an angular conical frustrum connector provided in accordance with an embodiment of the present application;

FIG. 49 is a front view of the angular conical frustrum connector;

FIG. 50 is a view of the angular conical frustrum connector;

FIG. 51 is a top view of the angular conical frustrum connector;

FIG. 52 is a sectional view of the angular conical frustrum connector along section 52 of FIG. 51;

FIG. 53 is a top view of a walled in-line pyramidal frustrum connector provided in accordance with an embodiment of the present application;

FIG. 54 is a sectional view of the walled in-line pyramidal frustrum connector along section 54 of FIG. 53;

FIG. 55 is a sectional view of the walled in-lined pyramidal frustrum connector along section 55 of FIG. 53;

FIG. 56 is a sectional view of the walled pyramidal frustrum connector along section 56 of FIG. 53;

FIG. 57 is a top view of a walled angular pyramidal frustrum connector provided in accordance with an embodiment of the present application;

FIG. 58 is a sectional view of the walled angular pyramidal frustrum connector along section 58 of FIG. 53;

FIG. 59 is a sectional view of the walled angular pyramidal frustrum connector along section 58 of FIG. 53;

FIG. 60 is a top view of a walled in-line conical frustrum connector provided in accordance with an embodiment of the present application;

FIG. 61 is a sectional view of the walled in-line conical frustrum connector along section 61 of FIG. 60;

FIG. 62 is a sectional view of the walled in-line conical frustrum connector along section 62 of FIG. 60;

FIG. 63 is a sectional view of the walled in-line conical frustrum connector along section 63 of FIG. 60;

FIG. 64 is a top view of a walled angular pyramidal frustrum connector provided in accordance with an embodiment of the present application;

FIG. 65 is a sectional view of the walled angular conical frustrum connector along section 65 of FIG. 64;

FIG. 66 is a sectional view of the walled angular conical frustrum connector along section 66 of FIG. 64;

FIG. 67 is a sectional view of the walled angular conical frustrum connector along section 67 of FIG. 64;

FIG. 68 is a front perspective view of a self correcting frustrum final assembly position of the in-line rail banister using conical frustrum connectors; and

FIG. 69 is a detailed view of the first conical frustrum connector frustrumly engaged with its baluster.

Like reference numerals are used in different figures to denote similar elements.

### DETAILED DESCRIPTION OF THE DRAWINGS

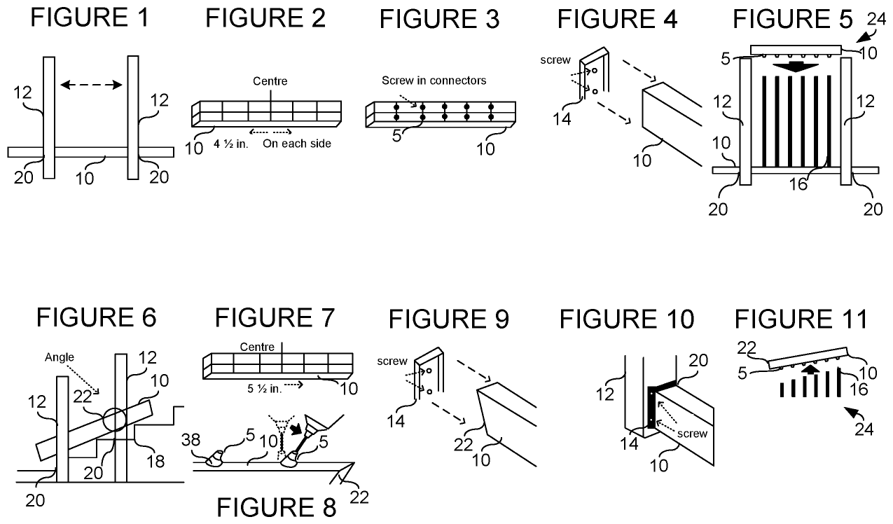

Referring to the drawings, FIG. 1 is a front view of two plumb 20 posts a given distance apart for an in-line rail 10. FIG. 6 is a front view of two plumb 20 posts a given distance apart for a stair rail 10. The posts are typycally 4 in×4 in (4×4). Before measuring the given distance between the posts, each post 12 needs to be plumb 20. This distance is used to cut the top and bottom rails. Take into account any additional hardware used. For example, a ½ in should be subtracted from the given distance if optional railing supports of ¼″ are used. If used, attach the rail support 14 to each rail 10 using, for example, screws. The top and bottom rail 10 are typically 2 in×2 in (2×2.) In the case of the stair rail 10, measure the angle 22 of the stairs 18 using the top and bottom rail 10 and cut the ends of the top and bottom rails at the measured angle 22 of the stairs 18.

FIG. 2 is a top view of a top and bottom rail 10 marked a given distance apart on centre starting from the centre. FIG. 7 is a top view of a top and bottom rail 10 marked a given distance apart on centre starting from the centre. The specific given distance between the marks is typically specified in building codes. Consult the proper authority for your jurisdiction, such as for example, the National Building Code of Canada 2018 section 9, subsection 9.8 and other code requirements in your area. For example, the banister 24 of railings between 4×4 s should not exceed 6 in. according to some codes. In the example, the marks are 4½ in on centre starting from the centre of the rail 10.

FIG. 3 is a top view of the top and bottom rail 10 with a straight connector 5 screwed onto each mark. FIG. 8 is a perspective view of a top or bottom rail 10 with an angled connector 5 screwed onto each mark. Screw an appropriate connector 5 on each mark of each of the bottom and top rail 10. For an in-line rail 10 use in-line connectors. For a stair rail 10 use an angular connector 5. Although not expressly shown in the drawings, it is known to provide an angular connector 5 by using an in-line connector 5 with an angle piece 38.

FIG. 4 is a perspective view of a rail support 14 that can be attached to the end of the top and bottom rails. FIG. 9 is a perspective view of a rail support 14 that can be attached to the end of the top and bottom rails. FIG. 10 is a perspective view of the rail support 14 that can be attached to the plumb 20 posts. The bottom rail 10 can be set at the desired height. For example, for easier installation, a piece of 2×4 can be placed under the bottom rail 10 at each end, then the bottom rail 10 can be fastened to the posts with screws, e.g. through pre-drilled holes in the supports.

FIG. 5 is a front view of an ideal assembly of an in-line rail 10 banister 24 combining the top rail 10, bottom rail 10, connectors, and balusters. FIG. 11 is a front view of an ideal assembly of a stair rail 10 banister 24 combining the top rail 10, bottom rail 10, connectors, and balusters. Insert a baluster 16 on each connector 5 of the bottom rail 10. A rubber mallet can be used to ensure each baluster 16 is firmly connected to the bottom connector 5 on the bottom rail 10, resulting in an array of standing balusters, Invert the top rail 10 and position on top of the standing balusters. Ideally, one aligns each baluster 16 beginning at one end and keeps going until they are all inserted. When all balusters are successfully connected to the top connectors of the top rail 10, fasten the top rail 10 to the posts, e.g. using screws through pre-drilled holes in the support. Once fixed, remove the 2×4 pieces supporting the bottom rail 10.

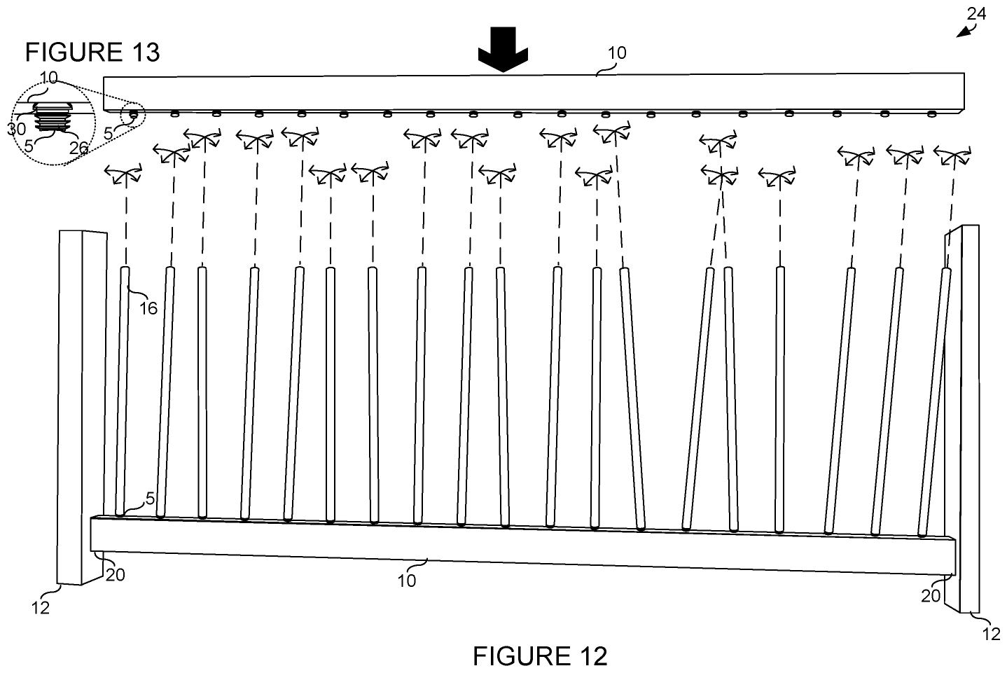

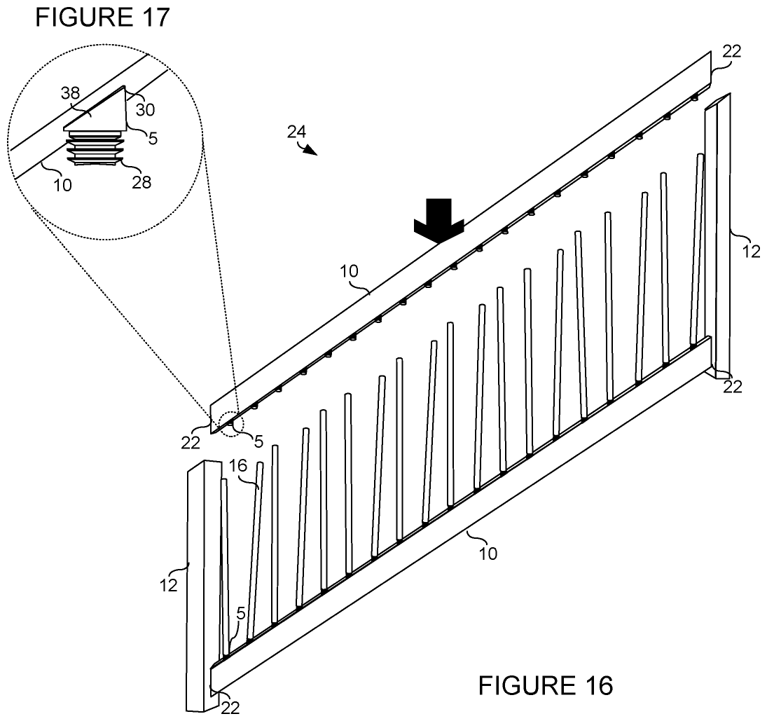

FIG. 12 is a front perspective view of a typical disconnected final assembly position of an in-line rail 10 banister 24 using traditional in-line connectors. FIG. 16 is a front perspective view of a typical disconnected final assembly position of a stair rail 10 banister 24. In practice, the typical disconnected final assembly position is not ideal. In practice, the balusters are not easily aligned to stand plumb 20, nor do they tend to stay that way given that the top of each baluster 16 can be moved somewhat away from plumb 20 in forward, backward, left and right direction. Once a baluster 16 is connected, aligning the next baluster 16 can be difficult since the top railing is now constrained at a fixed distance from the bottom rail 10 corresponding to the length of a baluster 16. As balusters get connected, the number of constraints increases, thereby increasing the likelihood that already connected balusters detach, either from the connectors at the top rail 10, or the bottom rail 10.

FIG. 13 is a detailed view of a first traditional in-line connector 26 disconnected from its baluster 16. FIG. 17 is a detailed view of a traditional angled connector 28 disconnected from its baluster 16. As shown in the detail, the traditional connectors at the top rail 10 start in a disconnected state from its corresponding baluster 16.

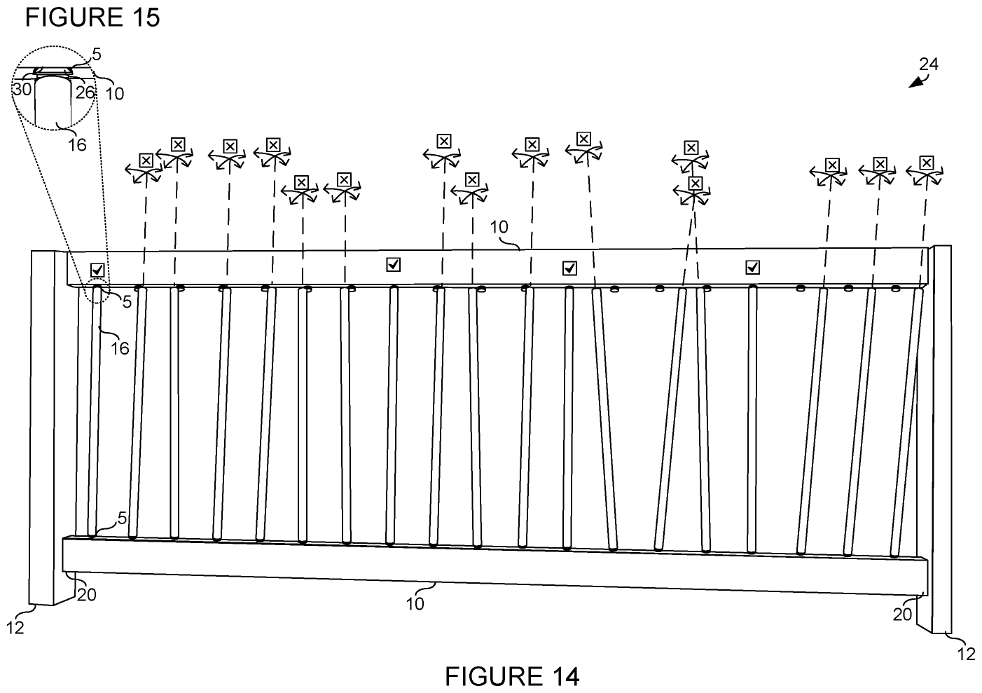

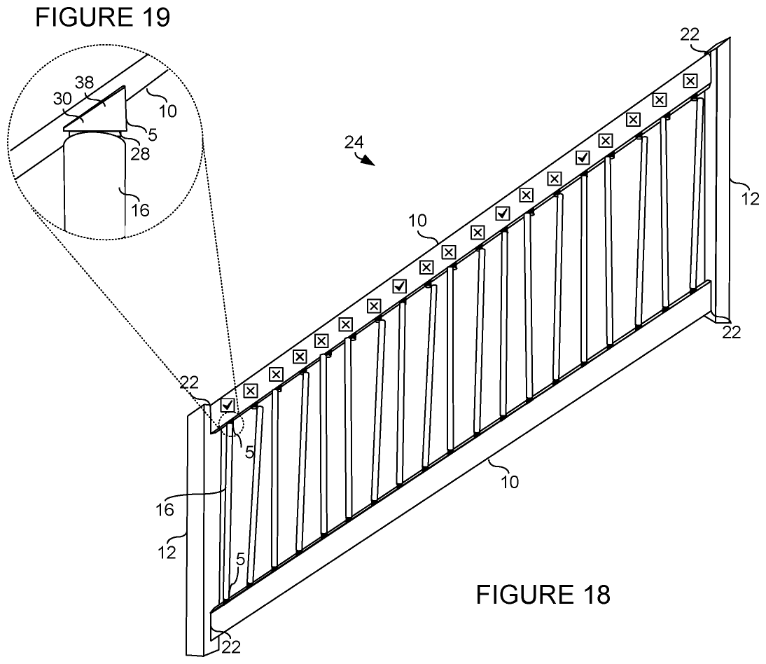

FIG. 14 is a front perspective view of a typical final assembly failure of the in-line rail 10 banister 24. FIG. 18 is a front perspective view of a typical final assembly failure of the stair rail 10 banister 24. As shown in the examples, although several balusters are correctly connected to their corresponding connector 5 as illustrated with a check mark, in the case of those baluster 16 indicated with an x mark, it may be difficult to align the other balusters easily with their corresponding top rail 10 connectors. FIG. 15 is a detailed view of the traditional in-line connector 26 connected to its baluster 16.

FIG. 19 is a detailed view of the traditional angled connector 28 connected to its baluster 16. As shown, when connected, it may be difficult to move the top rail 10 to allow other balusters to be aligned with their corresponding connectors.

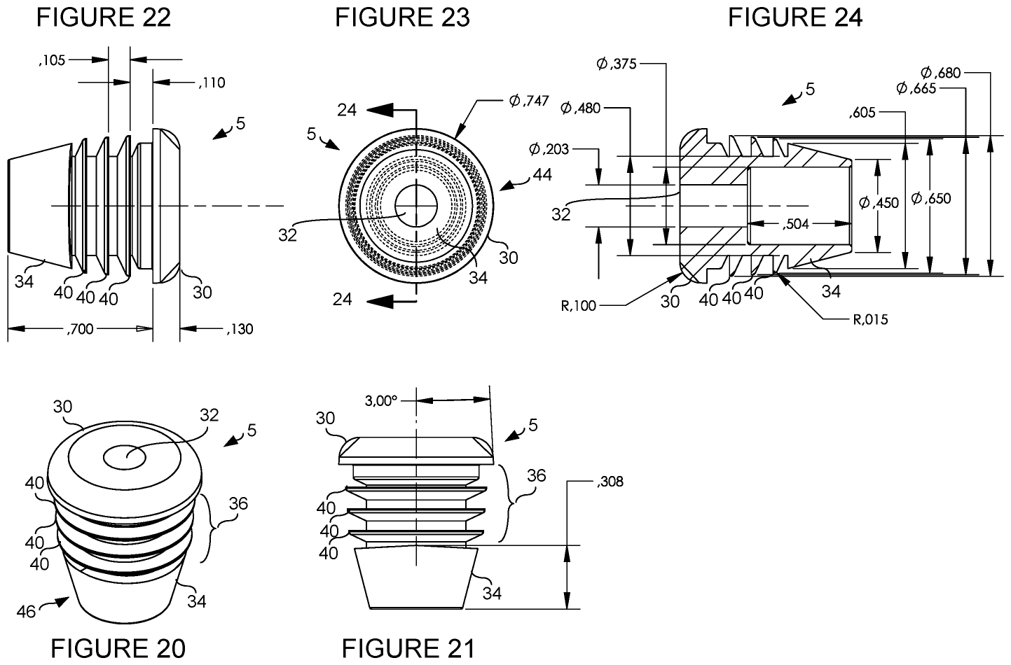

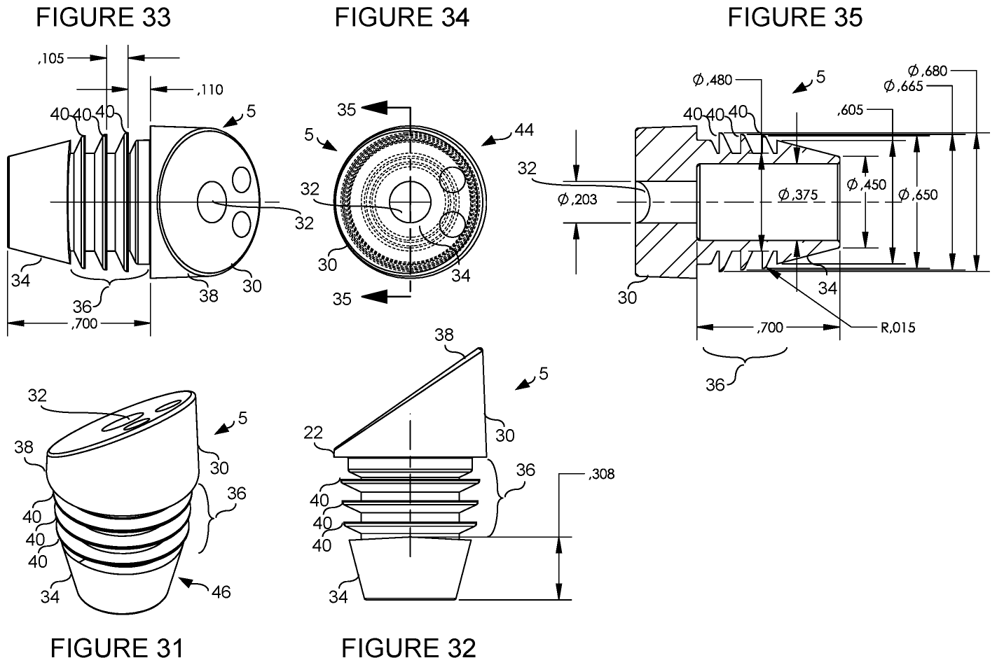

FIG. 20 is a front perspective view of an in-line conical frustrum 34 connector 5 provided in accordance with an embodiment of the present application. FIG. 21 is a front view of the in-line conical frustrum 34 connector 5. FIG. 22 is a side view of the in-line conical frustrum 34 connector 5. FIG. 23 is a top view of the in-line conical frustrum 34 connector 5. FIG. 24 is a sectional view of the in-line conical frustrum 34 connector 5 along section 24 of FIG. 23. FIG. 31 is a front perspective view of an angular conical frustrum 34 connector 5 provided in accordance with an embodiment of the present application. FIG. 32 is a front view of the angular conical frustrum 34 connector 5. FIG. 33 is a side view of the angular conical frustrum 34 connector 5. FIG. 34 is a top view of the angular conical frustrum 34 connector 5. FIG. 35 is a sectional view of the angular conical frustrum 34 connector 5 along section 35 of FIG. 34. As shown in the drawing, the connectors of FIGS. 20-24 and FIGS. 31-35 include a base 30 for adapting the connector 5 to a rail 10, a body 36 rigidly supported by the base 30 for frictionally fitting a baluster 16 when the baluster 16 is in a final assembly position, and a frustrum 34 having a conical shape 46 progressively conforming to the body 36 having a circular profile 44, the frustrum 34 for releasably engaging the baluster 16 when the baluster 16 16 is in a frustrumly engaged position, and a hole 32 set centrally through the frustrum 34 and the body 36, the hole 32 further counterbored centrally in the base 30 to receive a screw to secure the connector 5 to a rail 10. As shown in the drawing, a plurality of flange 40 permetrically connected to the body 36 are dimensioned for frictional fitment to the baluster 16. The connector 5 of FIGS. 31-35 further include an angle piece 38 integral to the base 30 to further adapt the connector 5 to an anfled rail 10, such as used in stairs 18. In alternative embodiments the angle piece 38 is seperate and not integral. In contrast with a traditional connectors, advantageously the frustrum 34 provided on the tip of the connectors facilitates alignment during the final assembly phase. Further advantageously, each frustrum 34 not only facilitates alignment with its corresponding baluster 16, but also between other connectors and their corresponding balusters as well, as will be shown next.

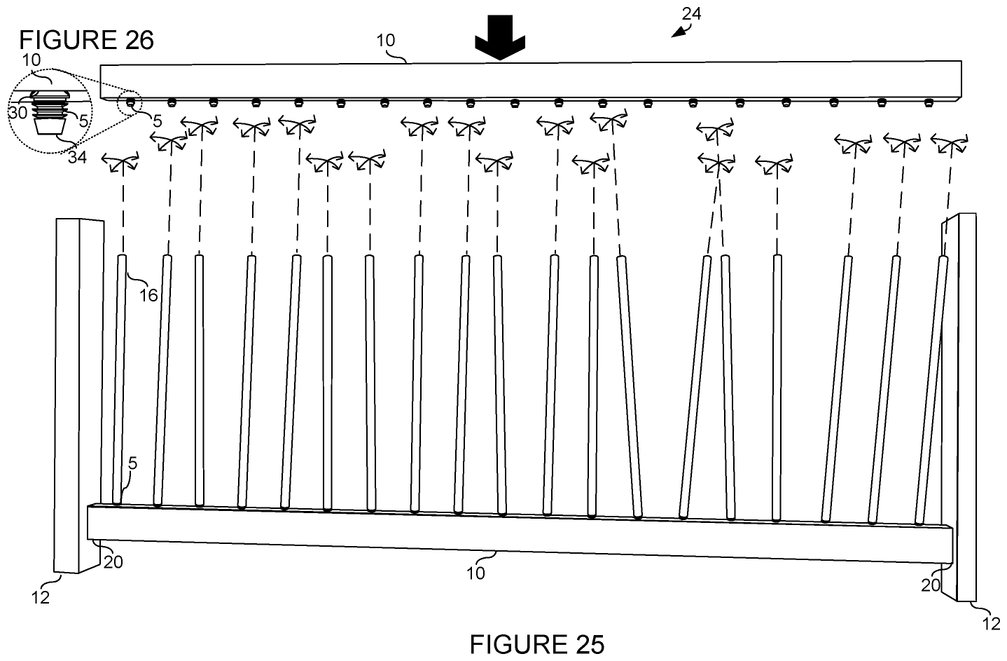

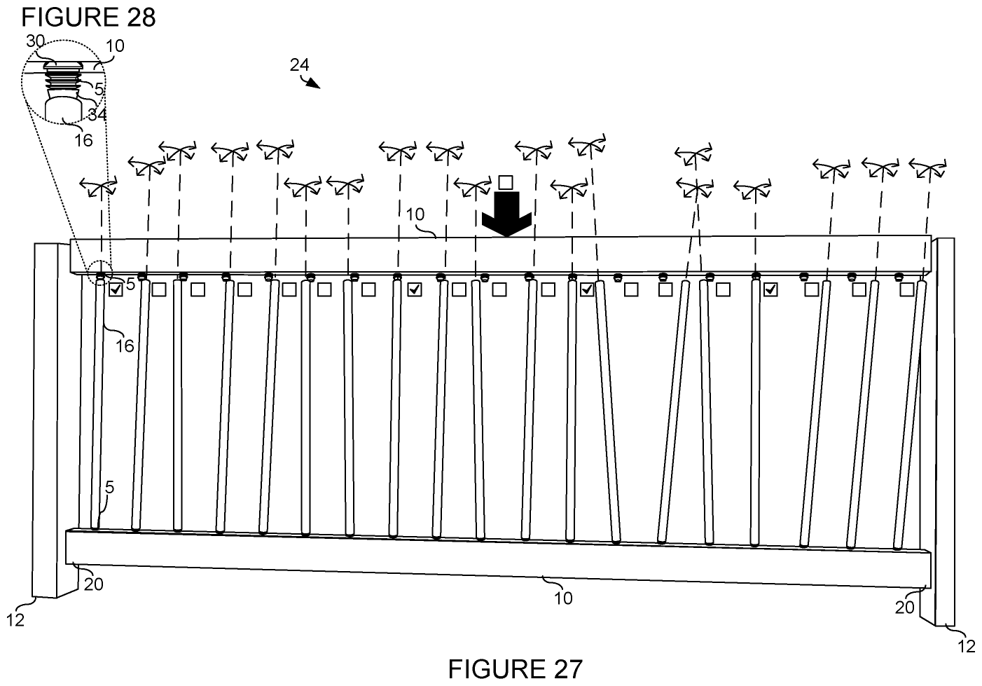

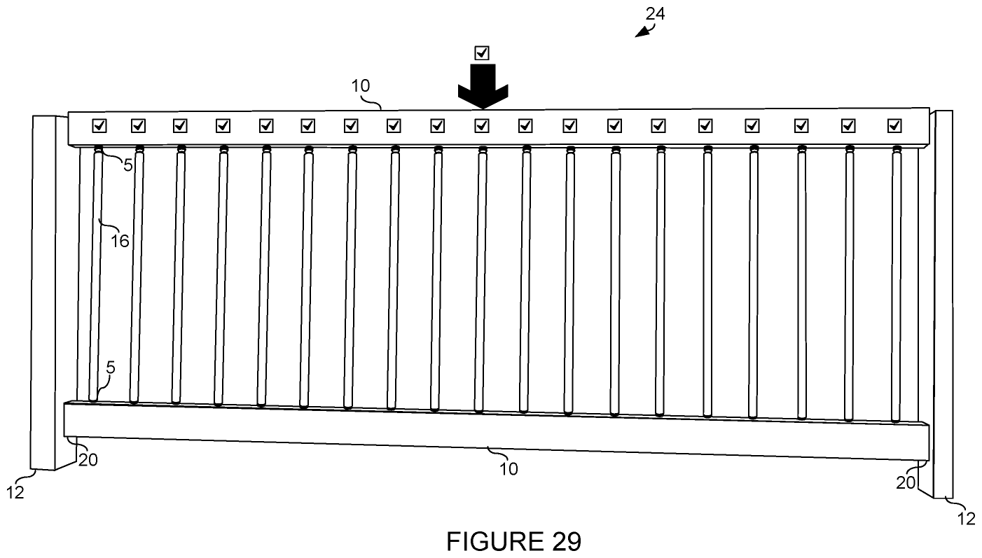

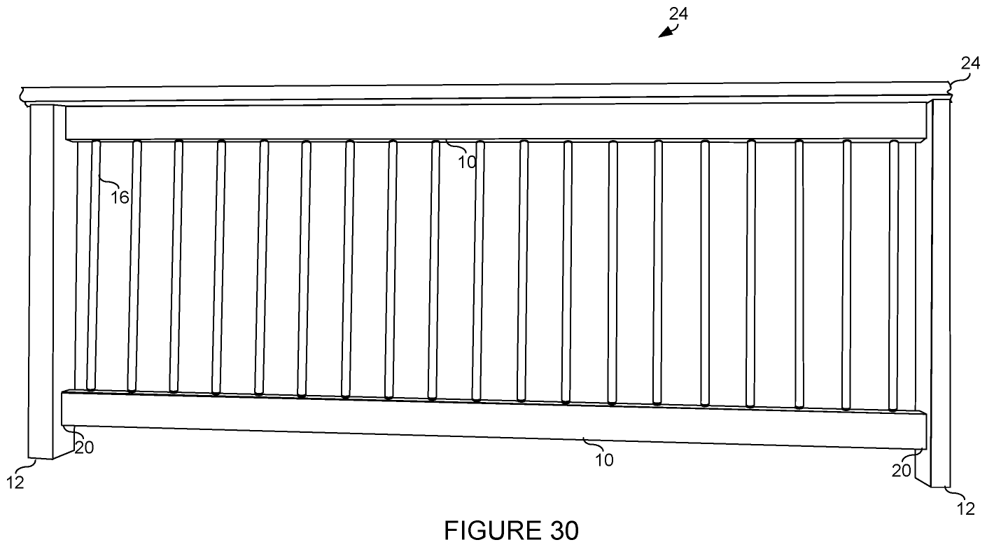

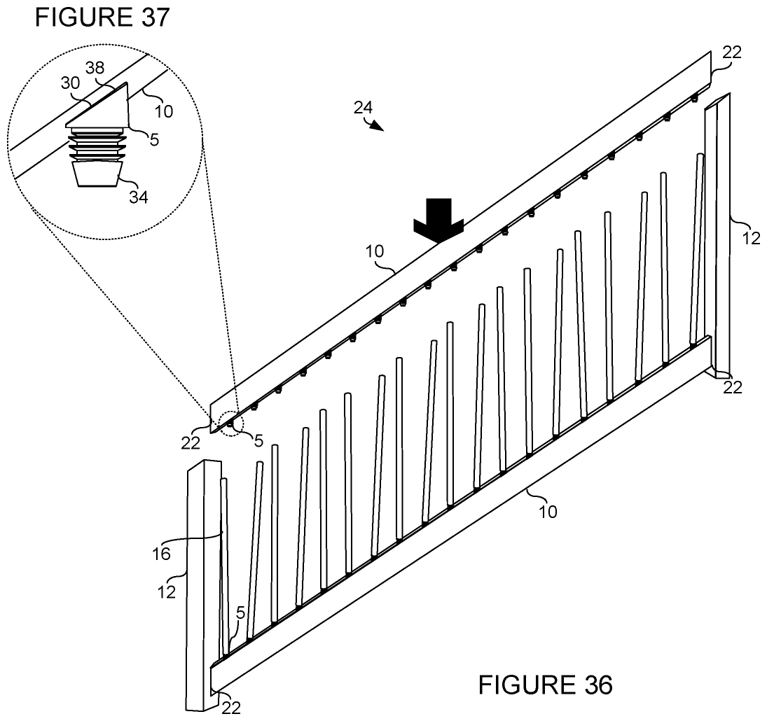

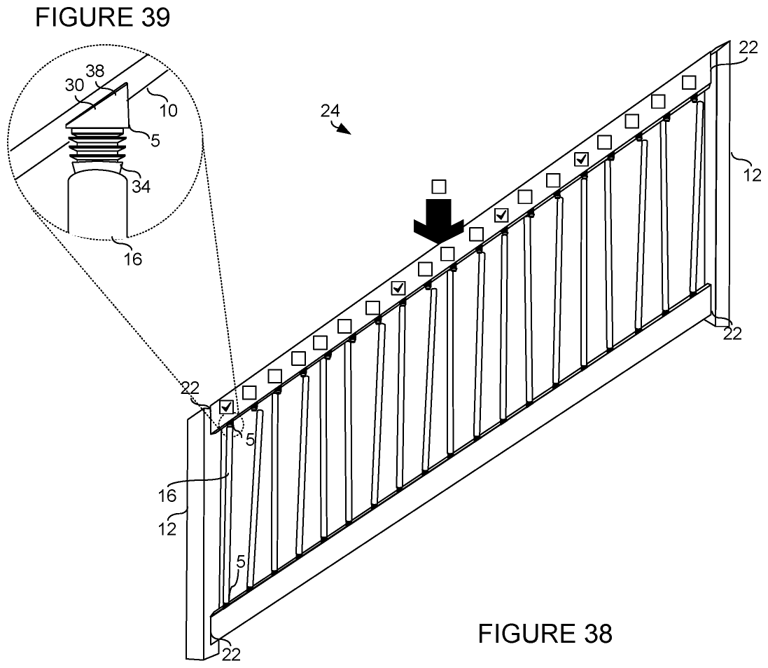

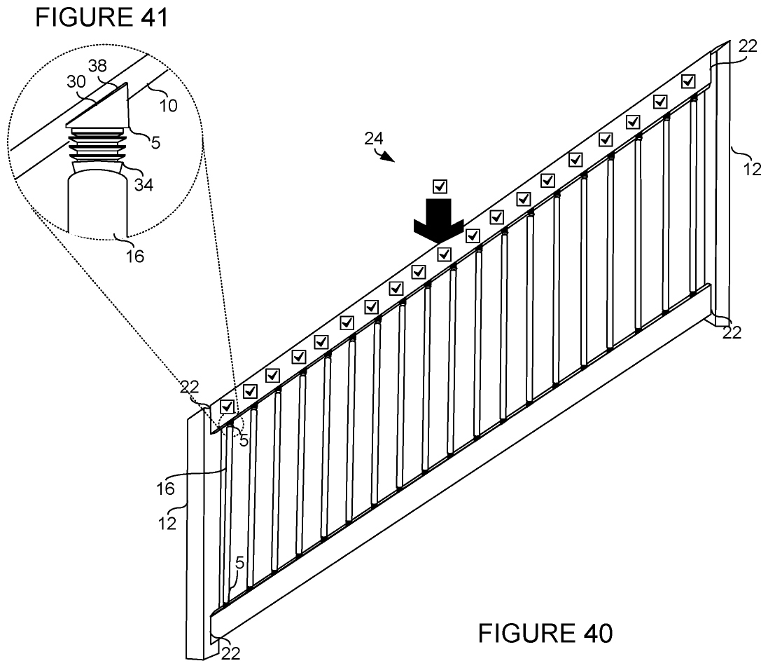

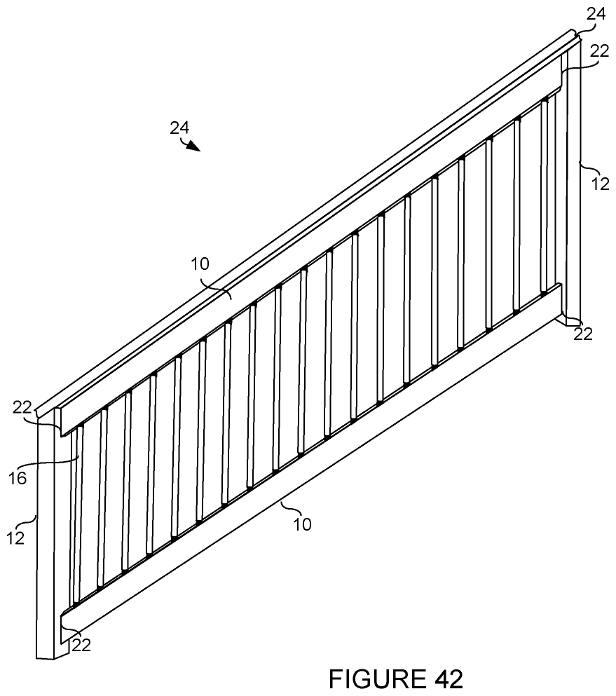

FIG. 25 is a front perspective view of a disconnected final assembly position of an in-line rail 10 banister 24 using in-line conical frustrum 34 connectors. FIG. 26 is a detailed view of a first in-line conical frustrum 34 connector 5. FIG. 27 is a front perspective view of a correctable frustrum 34 final assembly position of the in-line rail 10 banister 24 using in-line conical frustrum 34 connectors. FIG. 28 is a detailed view of the first in-line conical frustrum 34 connector 5 frustrumly engaged with its baluster 16. FIG. 29 is a front perspective view of a correct frustrum 34 final assembly position of the in-line rail 10 banister 24 using in-line conical frustrum 34 connectors. FIG. 36 is a front perspective view of a disconnected final assembly position of an stair rail 10 banister 24 using angular conical frustrum 34 connectors. FIG. 37 is a detailed view of a first angular conical frustrum 34 connector 5. FIG. 38 is a front perspective view of a correctable frustrum 34 final assembly position of the stair rail 10 banister 24 using angular conical frustrum 34 connectors. FIG. 39 is a detailed view of the first angular conical frustrum 34 connector 5 frustrumly engaged with its baluster 16. FIG. 40 is a front perspective view of a correct frustrum 34 final assembly position of the stair rail 10 banister 24 using angular conical frustrum 34 connectors. FIG. 41 is a detailed view of the first angular conical frustrum 34 connector 5 frustrumly engaged with its baluster 16. FIG. 42 is a front perspective view of a correct frustrum 34 final assembly success of the stair rail 10 banister 24 using angular conical frustrum 34 connectors. As shown, the provided frustrums allow the top rail 10 to be releasably engaged with the balusters such that from a disconnected final assembly position it is possible to attain a correctable frustrum 34 final position whereat only some of the balusters need to align with their respective connectors. Advantageously, the frustrums of each connector 5 that is correctly aligned provide head room for the balusters of correctable balusters to be aligned with their corresponding connector 5 and attain a correct position before any force need be applied to the top rail 10 to fully assemble the successful final assembly.

Although in the examples illustrated so far a tubular baluster 16 with circular profile 44 was used, it is envisaged that the frustrum 34 aspect of the present application can be adapted to any shape of baluster 16, including for example a rectangular baluster 16 with square profile 42. Furthermore, the addition of other features such as walls, and frictional engagements are also envisaged. Some examples of these alternative embodiments are further illustrated and described, below.

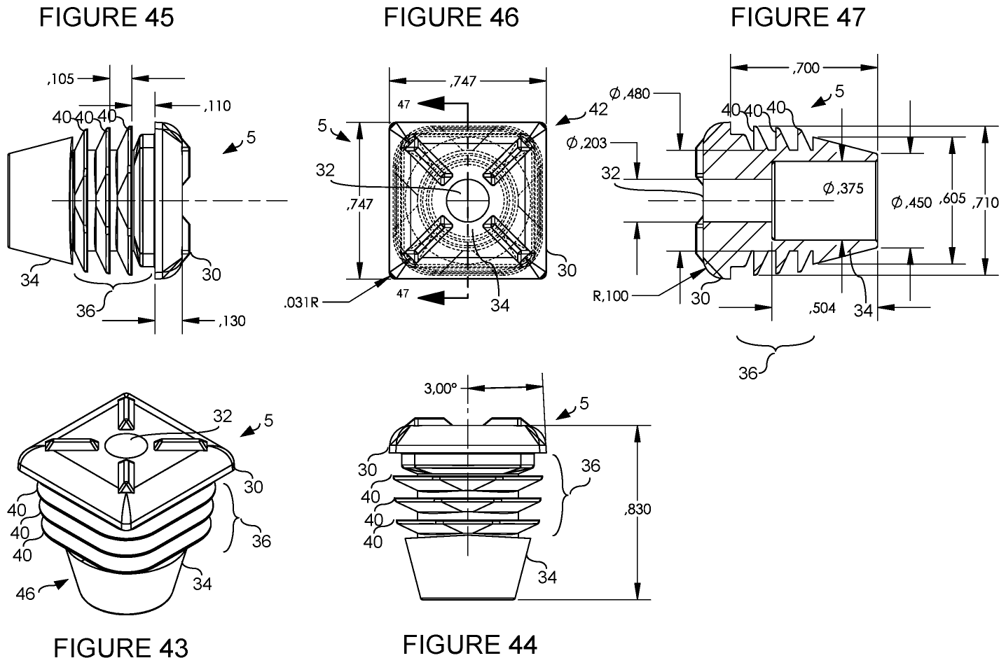

FIG. 43 is a perspective view of an in-line conical frustrum 34 connector 5 provided in accordance with an embodiment of the present application. FIG. 44 is a front view of the in-line conical frustrum 34 connector 5. FIG. 45 is a view of the in-line conical frustrum 34 connector 5.

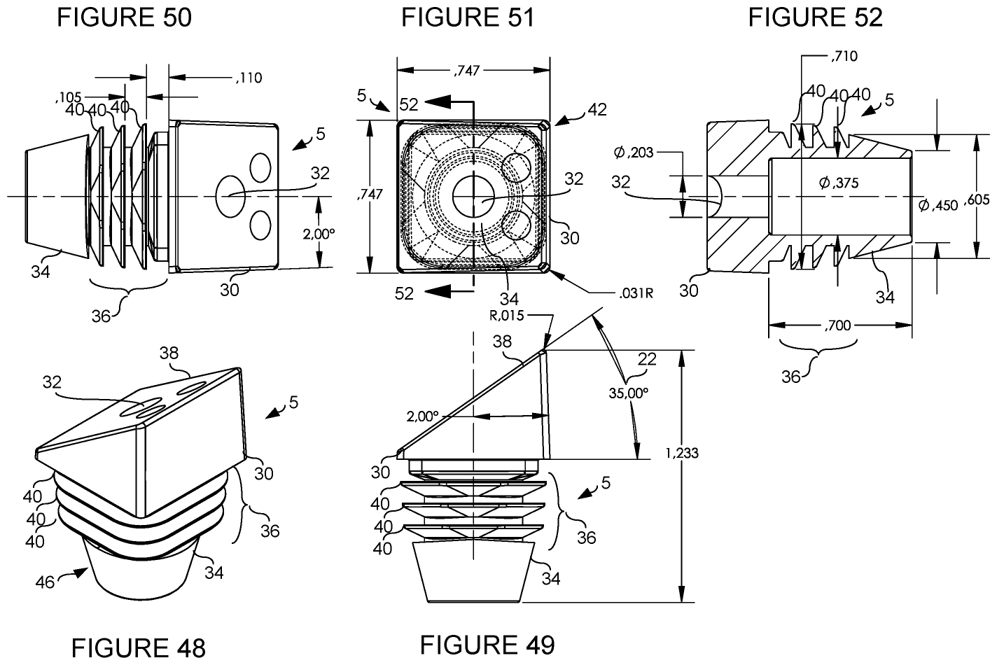

FIG. 46 is a top view of the in-line conical frustrum 34 connector 5. FIG. 47 is a sectional view of the in-line conical frustrum 34 connector 5 along section 47 of FIG. 46. As shown in the drawing, the connector 5 of FIGS. 43-47 include a base 30 having a rectangular profile for adapting the connector 5 to a rail 10, a body 36 having a rectangular profile rigidly supported by the base 30 for frictionally fitting a baluster 16 when the baluster 16 is in a final assembly position, and a frustrum 34 having a conical shape 46 progressively conforming to the body 36, the frustrum 34 for releasably engaging the baluster 16 when the baluster 16 is in a frustrumly engaged position, and a hole 32 set centrally through the frustrum 34 and the body 36, the hole 32 further counterbored centrally in the base 30 to receive a screw to secure the connector 5 to a rail 10. As shown in the drawing, a plurality of flange 40 permetrically connected to the body 36 are dimensioned for frictional fitment to the baluster 16. The connector 5 of FIGS. 48-52 further include an angle piece 38 integral to the base 30 to further adapt the connector 5 to an anfled rail 10, such as used in stairs 18.

FIG. 48 is a perspective view of an angular conical frustrum 34 connector 5 provided in accordance with an embodiment of the present application. FIG. 49 is a front view of the angular conical frustrum 34 connector 5. FIG. 50 is a view of the angular conical frustrum 34 connector 5. FIG. 51 is a top view of the angular conical frustrum 34 connector 5. FIG. 52 is a sectional view of the angular conical frustrum 34 connector 5 along section 52 of FIG. 51.

As shown in the drawing, the connector 5 of FIGS. 48-52 include a base 30 having a rectangular profile for adapting the connector 5 to a rail 10, a body 36 having a rectangular profile rigidly supported by the base 30 for frictionally fitting a baluster 16 when the baluster 16 is in a final assembly position, and a frustrum 34 having a conical shape 46 progressively conforming to the body 36, the frustrum 34 for releasably engaging the baluster 16 when the baluster 16 16 is in a frustrumly engaged position, and a hole 32 set centrally through the frustrum 34 and the body 36, the hole 32 further counterbored centrally in the base 30 to receive a screw to secure the connector 5 to a rail 10. As shown in the drawing, a plurality of flange 40 permetrically connected to the body 36 are dimensioned for frictional fitment to the baluster 16. The connector 5 of FIGS. 48-52 further include an angle piece 38 integral to the base 30 to further adapt the connector 5 to an anfled rail 10, such as used in stairs 18. In an alternative embodiment, the angle piece 38 is seperate and can be combined with the connector 5 of FIGS. 43-47 to provide the connector 5 of FIGS. 48-52.

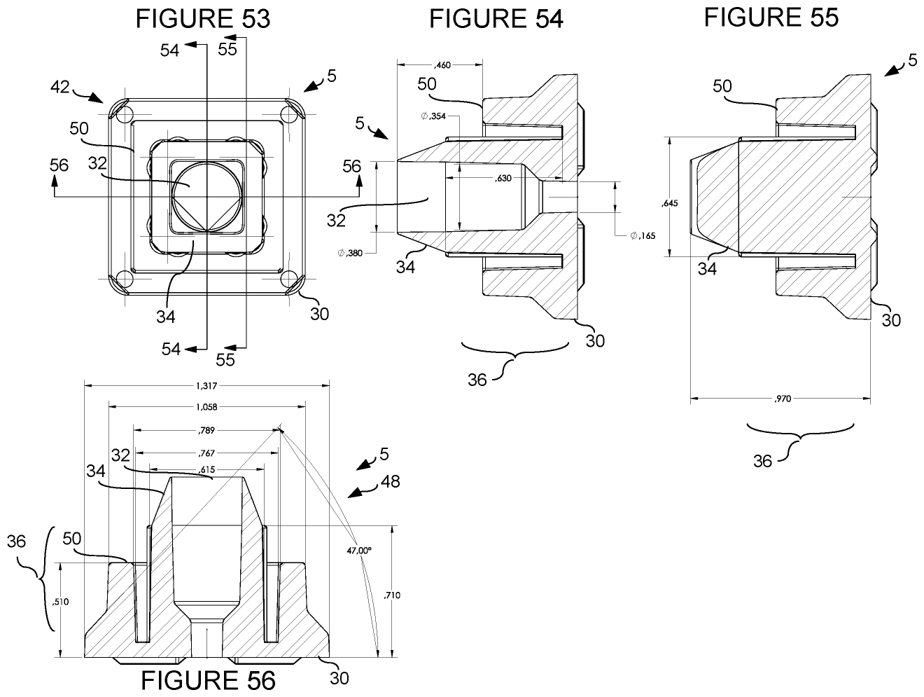

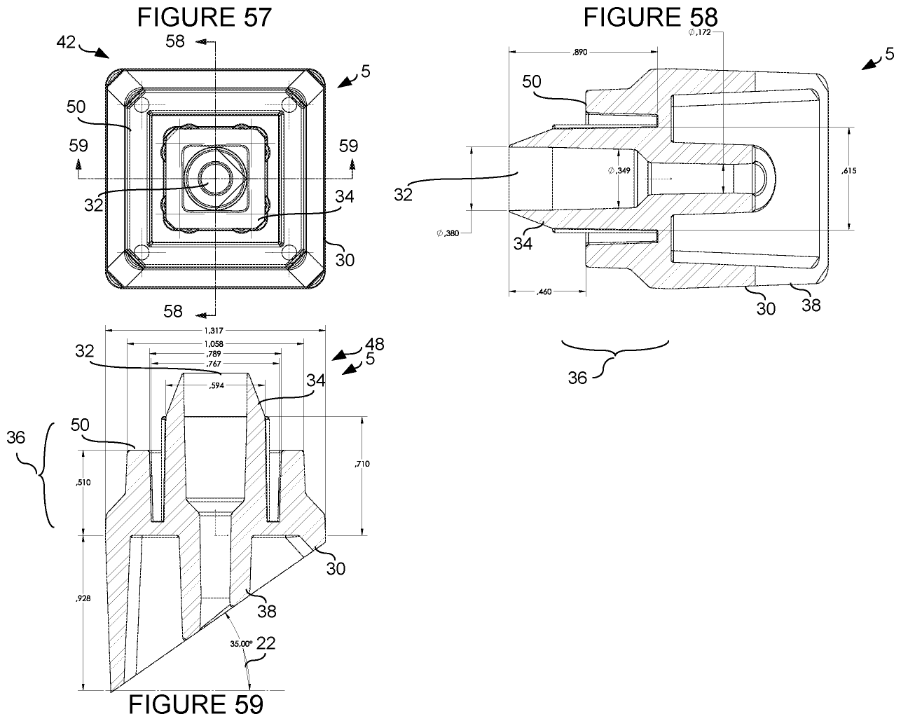

FIG. 53 is a top view of a walled in-line pyramidal frustrum 34 connector 5 provided in accordance with an embodiment of the present application. FIG. 54 is a sectional view of the walled in-line pyramidal frustrum 34 connector 5 along section 54 of FIG. 53. FIG. 55 is a sectional view of the walled in-lined pyramidal frustrum 34 connector 5 along section 55 of FIG. 53. FIG. 56 is a sectional view of the walled pyramidal frustrum 34 connector 5 along section 56 of FIG. 53. FIG. 57 is a top view of a walled angular pyramidal frustrum 34 connector 5 provided in accordance with an embodiment of the present application. FIG. 58 is a sectional view of the walled angular pyramidal frustrum 34 connector 5 along section 58 of FIG. 53. FIG. 59 is a sectional view of the walled angular pyramidal frustrum 34 connector 5 along section 58 of FIG. 53. As shown in the drawing, the connectors of FIGS. 53-56 and FIGS. 57-59 include a base 30 having a rectangular profile for adapting the connector 5 to a rail 10, a body 36 having a rectangular profile rigidly supported by the base 30 for frictionally fitting a baluster 16 when the baluster 16 is in a final assembly position, and a frustrum 34 having a pyramidal shape 48 progressively conforming to the body 36, the frustrum 34 for releasably engaging the baluster 16 when the baluster 16 is in a frustrumly engaged position, and a hole 32 set centrally through the frustrum 34 and the body 36, the hole 32 further counterbored centrally in the base 30 to receive a screw to secure the connector 5 to a rail 10. As shown in the drawing, a wall 50 permetrically connected to the body 36 are dimensioned for frictional fitment to the baluster 16 which is sandwhiched between the body 36 and the wall 50. The connector 5 of FIGS. 57-59 further includes an angle piece 38 integral to the base 30 to further adapt the connector 5 to an angled rail 10, such as used in stairs 18.

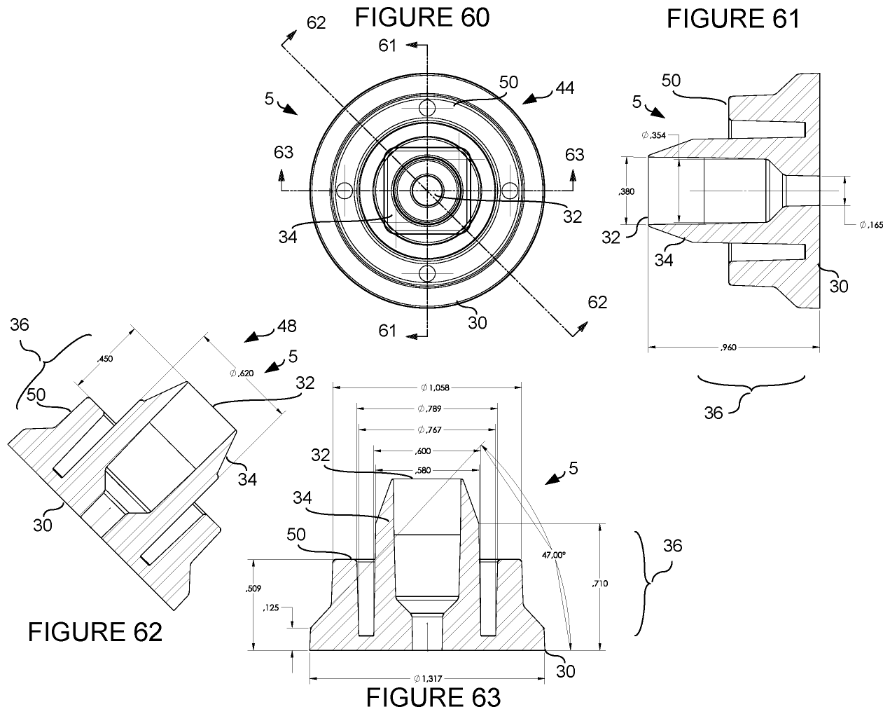

FIG. 60 is a top view of a walled in-line conical frustrum 34 connector 5 provided in accordance with an embodiment of the present application. FIG. 61 is a sectional view of the walled in-line conical frustrum 34 connector 5 along section 61 of FIG. 60. FIG. 62 is a sectional view of the walled in-line conical frustrum 34 connector 5 along section 62 of FIG. 60. FIG. 63 is a sectional view of the walled in-line conical frustrum 34 connector 5 along section 63 of FIG. 60;

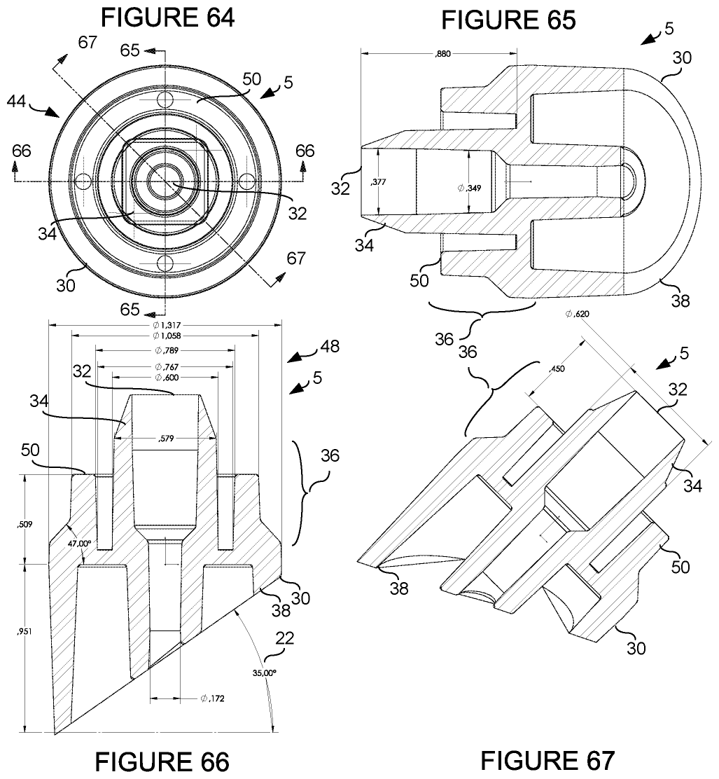

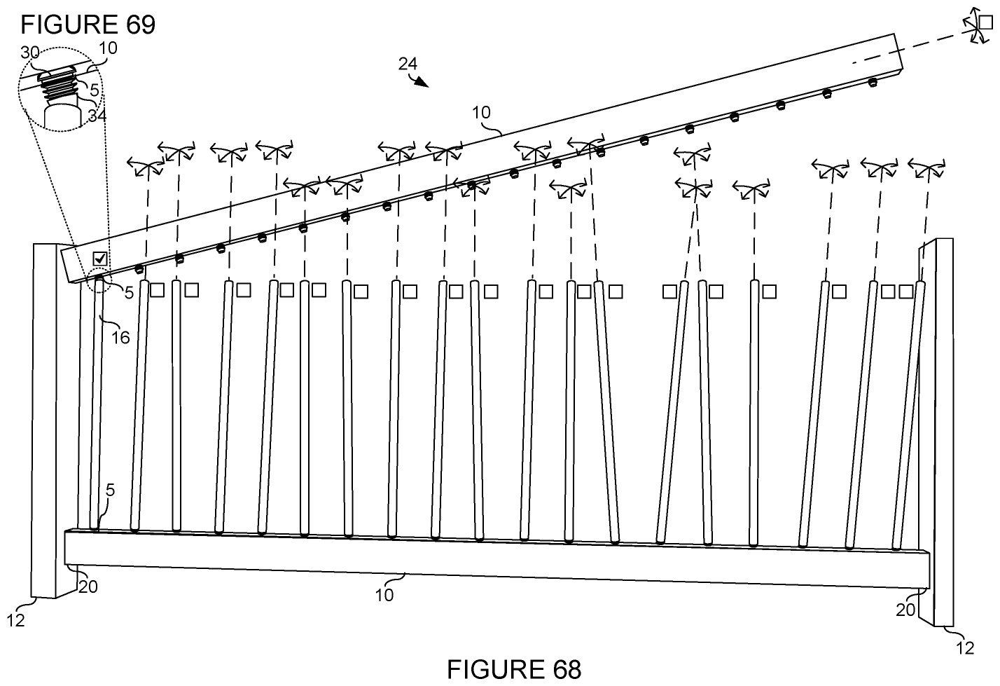

FIG. 64 is a top view of a walled angular pyramidal frustrum 34 connector 5 provided in accordance with an embodiment of the present application. FIG. 65 is a sectional view of the walled angular conical frustrum 34 connector 5 along section 65 of FIG. 64. FIG. 66 is a sectional view of the walled angular conical frustrum 34 connector 5 along section 66 of FIG. 64. FIG. 67 is a sectional view of the walled angular conical frustrum 34 connector 5 along section 67 of FIG. 64. As shown in the drawing, the connectors of FIGS. 60-63 and FIGS. 64-67 include a base 30 having a circular profile 44 for adapting the connector 5 to a rail 10, a body 36 having a circular profile 44 rigidly supported by the base 30 for frictionally fitting a baluster 16 when the baluster 16 is in a final assembly position, and a frustrum 34 having a concial shape progressively conforming to the body 36, the frustrum 34 for releasably engaging the baluster 16 when the baluster 16 is in a frustrumly engaged position, and a hole 32 set centrally through the frustrum 34 and the body 36, the hole 32 further counterbored centrally in the base 30 to receive a screw to secure the connector 5 to a rail 10. As shown in the drawing, a wall 50 permetrically connected to the body 36 is dimensioned for frictional fitment to the baluster 16 which is sandwhiched between the body 36 and the wall 50. The connector 5 of FIGS. 53-67 further includes an angle piece 38 integral to the base 30 to further adapt the connector 5 to an angled rail 10, such as used in stairs 18. In an alternative embodiment, the angle piece 38 is seperate and not integral to the base 30.

FIG. 68 is a front perspective view of a self correcting frustrum 34 final assembly position of the in-line rail 10 banister 24 using conical frustrum 34 connectors. FIG. 69 is a detailed view of the first conical frustrum 34 connector 5 frustrumly engaged with its baluster 16. The technique illustrated for assembly involves frustrumly engaging each connector 5 to its corresponding baluster 16 as the rail 10 is positionned between the plumb 20 post 12 such that there are no incorrect balusters and all balusters are in a frustrumly engaged position before pressure is applied to the rail 10 to put all of the balusters into a final assembly position.

The above-described embodiments of the present invention are intended to be examples only. Those of skill in the art may effect alterations, modifications and variations to the particular embodiments without departing from the scope of the present application.

What is claimed is:

1. A frustrumed baluster connector for rail banister, comprising:
means for adapting the connector to a rail;
means for frictionally fitting a baluster, rigidly supported to said means for adapting the connector to a rail;
means for releasably engaging the baluster to the rail, progressively conformed to said means for frictionally fitting the baluster; and
means for receiving a screw, centrally set to said means for releasably engaging the baluster to a rail, centrally set to said means for frictionally fitting the baluster, and centrally counterbored to said means for adapting the connector to the rail.

2. The frustrumed baluster connector for rail banister in accordance with claim 1, wherein said means for adapting the connector to a rail comprises a base.

3. The frustrumed baluster connector for rail banister in accordance with claim 1, wherein said means for frictionally fitting a baluster comprises a body.

4. The frustrumed baluster connector for rail banister in accordance with claim 1, wherein said means for releasably engaging the baluster to a rail comprises a frustrum.

5. The frustrumed baluster connector for rail banister in accordance with claim 1, wherein said means for receiving a screw comprises a hole.

6. A frustrumed baluster connector for rail banister, comprising:
a base, for adapting the connector to a rail;
a body, for frictionally fitting a baluster, rigidly supported to said base;
a frustrum, for releasably engaging the baluster to the rail, progressively conformed to said body; and
a hole, for receiving a screw, centrally set to said frustrum, centrally set to said body, and centrally counterbored to said base.

7. The frustrumed baluster connector for rail banister in accordance with claim 6, further comprising:
an angle piece, for further adapting the base to an angle of the rail, centrally set to said hole, and rigidly connected to said base.

8. The frustrumed baluster connector for rail banister in accordance with claim 6, further comprising a flange, for further frictional engagement with a baluster, perimetrically connected to said body.

9. The frustrumed baluster connector for rail banister in accordance with claim 6, further comprising a square profiled portion, for conforming to the profile of the baluster.

10. The frustrumed baluster connector for rail banister in accordance with claim 6, further comprising a circular profiled portion, for conforming to the profile of the baluster.

11. The frustrumed baluster connector for rail banister in accordance with claim 6, wherein the frustrum has a conical shape.

12. The frustrumed baluster connector for rail banister in accordance with claim 6, wherein the frustrum has a pyramidal shape.

11. The frustrumed baluster connector for rail banister in accordance with claim 6, further comprising a wall, for further frictional engagement with a baluster, perimetrically connected to said body.

12. A method of frustrumed baluster connector for rail banister, the method comprising the steps of:
providing a base, for adapting the connector to a rail;
providing a body, for frictionally fitting a baluster, rigidly supported to said base;
providing a frustrum, for releasably engaging the baluster to the rail, progressively conformed to said body; and
providing a hole, for receiving a screw, centrally set to said frustrum, centrally set to said body, and centrally counterbored to said base.

13. The method of frustrumed baluster connector for rail banister in accordance with claim 12, further comprising the step of frustrumly engaging the connector to a corresponding baluster in a frustrumly engaged position before pressure is applied to put the baluster into a final assembly position.
